(19) United States
(12) Patent Application Publication
(10) Pub. No.: US 2004/0045380 A1
(43) Pub. Date: Mar. 11, 2004

(54) Display for process transmitter

(76) Inventors: Scott D. Nelson, Plymouth, MN (US); John Brewer, Victoria, MN (US)

Correspondence Address: WESTMAN, CHAMPLIN & KELLY, A PROFESSIONAL ASSOCIATION, SUITE 1600 - INTERNATIONAL CENTRE, 900 SECOND AVENUE SOUTH, MINNEAPOLIS, MN, 55402-3319, US

(21) Appl. No.: 10/236,875

(22) Filed: Sep. 6, 2002

(51) Int. Cl. G01D 7/00

(52) U.S. Cl. 73/866.3; 73/866.1

(57) ABSTRACT

A transmitter for use in a process control system for monitoring an industrial process includes a housing having a top and a bottom and a height extending therebetween. A parallelogram display is mounted to the housing. Sides of the parallelogram display are arranged at angles relative to the height of the housing.

### BACKGROUND OF THE INVENTION

The present invention relates to equipment used to monitor and control industrial processes. More specifically, the present invention relates to displays for transmitters which are used to measure process variables of an industrial process.

Industrial processes are used to monitor and control process fluids such as for manufacturing or refining. Example industrial processes include oil refineries, food manufacturing plants, paper pulp preparation facilities, and many others.

In industrial processes, it is often necessary for an operator to obtain information regarding the operation of the process. Remote units, known as “transmitters,” are coupled to the process and transmit information related to process variables (pressure, temperature, flow rate, etc.) to a control room. The process variables can be viewed or operated upon with equipment in the control room.

In some instances, it is desirable for an operator to view information from a process transmitter directly. Therefore, some process transmitters include displays which are used to directly display the measured process variable or other information related to the transmitter on a face of the transmitter. For example, an operator can use the display to calibrate or configure the process transmitter.

Although process transmitters have many physical configurations, a common design includes a housing having a process coupling side or a process couple face and a cylindrical cavity which houses various transmitter circuitry. The cylindrical housing arranged perpendicular to the process coupling face and is sealed with end caps which screw into each end of the cylinder. When a display is added to such a transmitter, it is typically located near one of the end caps. The end cap can have a clear window such that the display can be viewed externally. The display itself is typically rectangular and is placed squarely on the transmitter housing, i.e., it is oriented such that the long sides of the rectangular display are parallel to a width of the transmitter and the short sides are parallel to a height. Information is then displayed in a standard fashion across the width of the rectangular display, with the displayed characters and symbols aligned with the sides of the display.

### SUMMARY OF THE INVENTION

A transmitter for use in a process control system for monitoring an industrial process includes a housing having a top and a bottom and a height extending therebetween. A process variable sensor is configured to sense a process variable of the process and provide a process variable output to transmitter circuitry which provides a display output. A parallelogram display is mounted to the housing with sides of the parallelogram display at angles relative to the height of the housing. In another aspect, characters are aligned at an angle with a parallelogram display.

### BRIEF DESCRIPTION OF THE DRAWINGS

FIG. 1 is a side plan view of a transmitter including a prior art display.

FIG. 2 is a side plan view of a transmitter including a display in accordance with an example embodiment of the present invention.

FIGS. 3A and 3B are side plan views of the display of the display of FIG. 2 and illustrates the display of different types of information.

FIG. 3C is a front plan view of the display showing segments of the display.

FIG. 4 is an exploded perspective view of a transmitter including the display of FIGS. 3A through 4.

### DETAILED DESCRIPTION OF THE PREFERRED EMBODIMENTS

The present invention includes a process control transmitter having a display which is angled relative to a height and a width of a transmitter. This configuration allows additional information to be shown across the display. In one aspect, an angled parallelogram display is configured to display characters or data in a horizontal and/or vertical direction. As the display is angled relative to the transmitter height and width, the horizontal and vertical directions form an angle with sides of the display which is between 0 and 90°. In one specific embodiment, the angle is about 45°. In one aspect, a parallelogram display is provided in which characters on the display are angled relative to sides of the display.

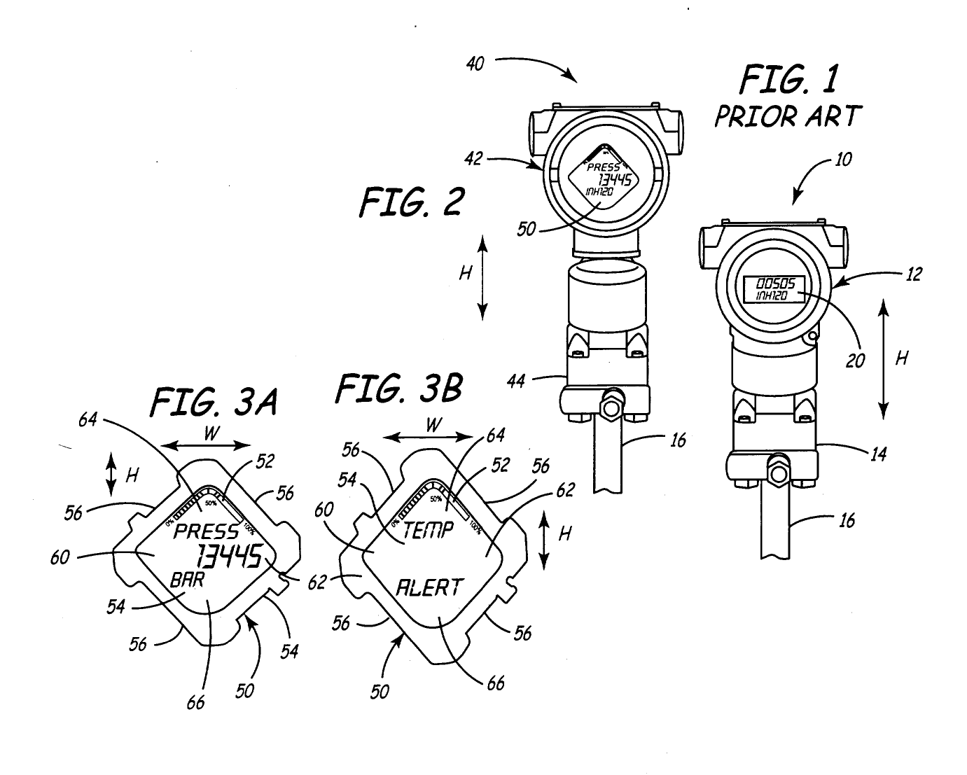

FIG. 1 is a side plan view of a prior art transmitter 10 for use in a process control system for monitoring an industrial process. Transmitter 10 includes a housing 12 which couples to process piping 16 to a process coupling 14. Housing 12 extends in a height direction H which is a direction away from the process coupling 14. A width direction is perpendicular to the height direction.

As illustrated in FIG. 1, transmitter 10 includes a display 20. Display 20 is a rectangular display which is arranged squarely with the height and width directions i.e., the short sides of the rectangle of the display are oriented parallel with the height direction and the long sides of the rectangle are oriented perpendicular to the height direction. Further, the characters on display 20 are also aligned with the sides of the rectangle. Frequently, LCDs (liquid crystal display) are used in which information is conveyed by activating elongate liquid crystal segments. Although displays which use segments are limited in the types of graphics and characters which can be displayed, a display with seven segments can be arranged such that all numbers can be illustrated. Further, a display with fourteen segments can be used to display alphabetical characters in addition to numeral characters. More complex graphics can be displayed using a matrix of dots.

FIG. 2 is a side plan view of a transmitter 40 in accordance with one embodiment of the present invention. Transmitter 40 includes housing 42 and process coupling 44 which couples to process piping 16. In the arrangement shown in FIG. 2, a parallelogram display, specifically a display 50 is oriented such that sides of the square or rectangular display are at an angle to the height direction of the transmitter. In one embodiment, the rectangle comprises a square and the sides are all at a 45° angle to the height and width directions of transmitter 40. Further, characters on the display 50 may be arranged at an angle relative to the sides of the display. In this embodiment, the angle of some of the characters relative to the sides of the display 50 are the same as the angle of the sides of the display 50 relative to the height and width directions of the transmitter 40 such that the characters aligned in a direction perpendicular to the height direction. When using a segmented display, many of the segments which are used to form numbers are oriented perpendicular to and parallel with the height direction.

Although the present invention includes a display which is a parallelogram, in one preferred embodiment, both sides of the parallelogram are parallel to thereby form either a rectangle or a square. Although a rectangular (specifically a square) display is shown, in one aspect parallelogram displays can be used.

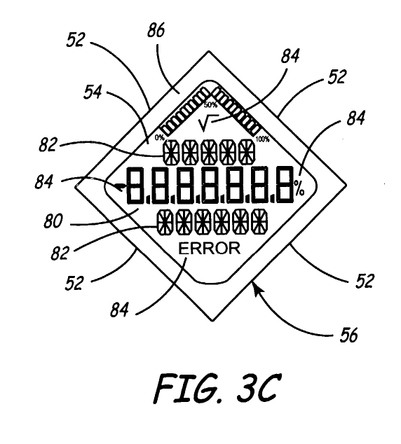

FIGS. 3A and 3B are front plan views of display 50 showing different types of display information. Display 50 is shown with a graphical display 52 which comprises a bar graph oriented around a top corner 64 of the parallelogram. It is appreciated, that by following the angles of the parallelogram, efficient use is made of the display area. Alphanumeric information 54 is also shown on the display 50. The alphanumeric information 54 is arranged at an angle relative to sides 56 of the display. In this embodiment, the alphanumeric information is at an angle of 45° to each of the four sides 56 of display 50. The display 50 has a height H and a width W and the alphanumeric information is aligned parallel with the width W and perpendicular to the height H. The alphanumeric information is formed using elongate display segments, for example, liquid crystal segments. For those liquid crystal segments used to display numerical information, the segments are aligned parallel to either the width or the height of the display 50. As used herein, a “character axis” is the axis along which characters are aligned, such as parallel to the width or height directions. This configuration allows information to be displayed between two opposed corners 60 and 68 of the parallelogram display. With such a configuration, relatively large alphanumerics or other information can be displayed between the two opposed side corners 60 and 62. Information can further be shown in a smaller form in a top corner 64 and a bottom corner 66 of the display 50. It is appreciated that some characters may be parallel to the width of the display while other characters may follow the sides and/or angles of the display (i.e., the bar graph shown in the top corner) or otherwise be arranged at any desired angle to better utilize the display area.

FIG. 3C is a front plan view of display 50 showing various characters and display segments. Display 50 includes a numeric display portion 80 which consists of seven separate seven segment display elements and adjacent periods arranged across opposed corners of display 50. Also illustrated in FIG. 3C are alphanumeric portions 82 which comprise a row of five and a row of six separate fourteen segment display elements arranged across the width of display 50. Fixed display elements 84 are also shown in FIG. 3C. In this example, they include the square root sign, a minus sign, the percent sign, and the word “ERROR.” The present invention can include other display configurations and formats. In one embodiment, the present invention is implemented using liquid crystal or light emitting diode elements. However, any display technology can be used. Although display 50 is shown including segments and fixed display elements, the display of the present invention can also comprise individual dots to form a dot matrix or other display techniques. A dot matrix display provides more flexibility in that the dots can be arranged to display any desired character.

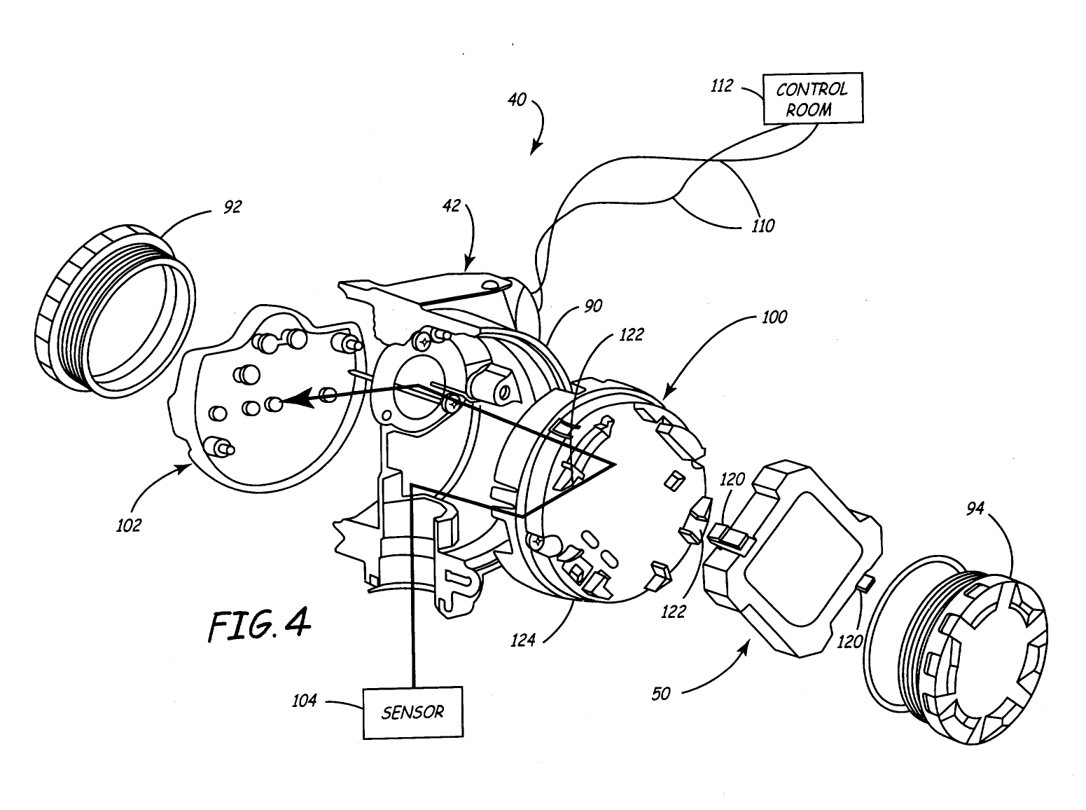

FIG. 4 is an exploded view of transmitter 40 showing the various components which are carried inside housing 42. Housing 42 includes a cylindrical section 90 which is sealed by end cap 92 and 94. Within cylindrical section 90 is transmitter circuitry 100 and terminal block 102. Transmitter circuitry 100 is configured to couple to a process variable sensor 104. Sensor 104 can be located internal to housing 42 or externally. Process variable data from sensor 104 is received by transmitter circuitry 100 and coupled to a two-wire process control loop 110 through a terminal block 102. Process control loop 110 couples to a control room 112. Process control loop 110 can be in accordance with any appropriate technique or standard. For example, in one preferred embodiment loop 112 comprises a two wire process control loop which carries a current level of the between 4 milliamps and 20 milliamps. In some embodiments transmitter circuitry 100 including display 50 is completely powered with power received over loop 110.

Display 50 can be configured to snap into circuitry 100 using tabs 120 which mate with receptacle tabs 122. An electrical plug on display 50 plugs is received by circuit plug 124.

The angle design of the display of the present invention allows for increased usability of the glass area of a display, especially the center set of characters which extend across the width of the display. Other techniques can also be used to increase the display area such as using a round display. However, these are more difficult to obtain or fabricate and therefore more expensive. Electrical contacts for coupling to such displays can also be problematic. In the specific embodiment set forth herein, there are about 240 segments to the display which require 42 electrical contacts which are spaced along two sides of the glass used for the display. The use of the rotated display is relatively inexpensive and provides a sufficient number of contacts along the edges for display of the desired information.

Although the display of the present invention is shown with a particular transmitter configuration, the display can be used with other process control instrumentation (including any process device which is located in the field such as control elements) in which it is desirable to display information. The invention efficiently utilizes the space available on the face of the instrumentation. External space for displaying information on a process device is limited. The invention allows additional data to be displayed, or to be displayed in a more readable format, then in typical prior art designs. Although a parallelogram and specifically a square configuration are illustrated, the present invention can be used with other configurations including rectangles. It is further appreciated that the parallelogram display does not require rounded or curved corners (such as in circular displays). Such rounded or curved corners are difficult to manufacture and increase manufacturing costs.

Although the present invention has been described with reference to preferred embodiments, workers skilled in the art will recognize that changes may be made in form and detail without departing from the spirit and scope of the invention. The sensor and/or display can be located remotely to the transmitter or transmitter circuitry.

What is claimed is:

1. A transmitter for use in a process control system for monitoring an industrial process, comprising:
a housing having a top and a bottom and a height extending therebetween;
a process variable sensor configured to sense a process variable of the process and responsively provide a process variable output;
transmitter circuitry in the housing configured to provide a display output;
a parallelogram display mounted to the housing with sides of the parallelogram display at an angle relative to the height of more than zero degrees and less than ninety degrees; and
the display configured to display information in response to the display output.

2. The apparatus of claim 1 wherein the parallelogram comprises a rectangle.

3. The apparatus of claim 1 wherein the parallelogram display comprises a square.

4. The apparatus of claim 1 wherein an angle between a side of the parallelogram display and the height is forty five degrees.

5. The apparatus of claim 1 wherein the parallelogram display includes at least one display segment having a length and display segment length is generally parallel with the height.

6. The apparatus of claim 5 including a second display segment arranged at an angle to the height.

7. The apparatus of claim 1 wherein the parallelogram display includes at least one display segment having a length and the display segment length is generally perpendicular to the height.

8. The apparatus of claim 7 including a second display segment arranged at an angle to the height.

9. The apparatus of claim 1 including a mount configured to couple to the process and the height is in a direction away from the mount.

10. The apparatus of claim 1 wherein the sensor is located remotely from the transmitter housing and coupled to the transmitter circuitry through an electrical connection.

11. The apparatus of claim 1 wherein the sensor is contained in the transmitter housing.

12. The apparatus of claim 1 wherein the display is positioned remotely from the transmitter circuitry.

13. A transmitter for use in a process control system used to monitor an industrial process, comprising:
a housing;
a process variable sensor configured to sense a process variable of the process and provide a process variable output responsively;
transmitter circuitry coexisting in the housing configured to provide a display output; and
a parallelogram display configured to display information related to the display output and having four sides and mounted to the housing configured to display a plurality of characters aligned with a character axis, the character axis arranged at an angle of more than zero degrees and less than ninety degrees to the sides of the parallelogram display.

14. The apparatus of claim 13 wherein at least a portion of the characters are aligned with the sides of the display.

15. The apparatus of claim 14 wherein an angle between the character axis and a side of the parallelogram display is about 45°.

16. The apparatus of claim 14 wherein the parallelogram comprises a rectangle.

17. The apparatus of claim 14 wherein the parallelogram display comprises a square.

18. The apparatus of claim 13 wherein the housing has a top and a bottom and a height extending therebetween and sides of the parallelogram are at an angle relative to the height of more than zero degrees and less than ninety degrees.

19. The apparatus of claim 18 wherein an angle between a side of the parallelogram display and the height is forty five degrees.

20. The apparatus of claim 18 wherein the parallelogram display includes at least one display segment having a length which is generally parallel with the height.

21. The apparatus of claim 18 wherein the parallelogram display includes at least one display segment having a length which is generally perpendicular to the height.

22. The apparatus of claim 18 including a mount configured to couple to the process and the height is in a direction away from the mount.

23. The apparatus of claim 13 wherein the sensor is located remotely from the transmitter housing and coupled to the transmitter circuitry through an electrical connection.

24. The apparatus of claim 13 wherein the sensor is contained in the transmitter housing.
